(19) United States
(12) Patent Application Publication
(10) Pub. No.: US 2025/0284587 A1
(43) Pub. Date: Sep. 11, 2025

(54) METHOD AND DEVICE FOR CORRECTING ERRORS IN RESISTIVE MEMORIES OR FLASH MEMORIES

(71) Applicant: COMMISSARIAT A L’ENERGIE ATOMIQUE ET AUX ENERGIES ALTERNATIVES, PARIS (FR)

(72) Inventor: Valentin GHERMAN, GRENOBLE (FR)

(21) Appl. No.: 19/071,552

(22) Filed: Mar. 5, 2025

(30) Foreign Application Priority Data
Mar. 7, 2024 (FR) 2402306

(51) Int. Cl. G06F 11/10

(52) U.S. Cl. CPC G06F 11/1044

(57) ABSTRACT

An error correction in resistive memories or flash memories protected by an error-correcting code is provided. A device makes it possible to correct at least two erroneous bits per code word stored in memory and combines a correcting module capable of correcting up to r−1 erroneous bits per code word, and a detecting module makes it possible to check the number of erroneous bits per code word, and is arranged to detect whether the read code word contains at most r−1 erroneous bits. If it does not, a sequence of decoding operations is initiated on a succession of words, each of which contains a single inverted bit with respect to the read code word. A check is carried out to check whether the number of erroneous bits in the version of the code word with inversion of one bit has become correctable in order to correct the code word.

### CROSS-REFERENCE TO RELATED APPLICATION

This application claims priority to foreign French patent application No. FR 2402306, filed on Mar. 7, 2024, the disclosure of which is incorporated by reference in its entirety.

### FIELD OF THE INVENTION

The invention relates to the field of resistive memories or flash memories, and more particularly relates to a method and device making it possible to improve error correction in such memories.

### BACKGROUND

Resistive random-access memory (RRAM) is non-volatile memory having a high operating speed, a low power consumption and a long lifespan. For these reasons, resistive memories are among the most promising memory technologies for replacing both random-access memories and modern non-volatile memories, such as flash memories.

There are a number of resistive memory technologies. Mention may in particular be made of conductive-bridging random-access memory (CBRAM), or oxide-based random-access memory (OxRAM), or even phase-change memory (PCM).

A resistive memory consists of a multitude of resistive memory cells arranged in rows and columns so as to form a matrix array. An RRAM memory cell is equipped with at least one resistive element the conductance of which is able to be modified.

One factor limiting widespread market adoption of resistive memory is the high bit error rates encountered during read operations. Bit error rate (BER) is impacted by instability in the HRS and LRS values of the resistances programmed in the memories (HRS standing for High Resistance State and LRS standing for Low Resistance State). The article by B. Giraud et al., “Benefits of Design Assist Techniques on Performances and Reliability of a RRAM Macro”-DOI: 10.1109/IMW56887.2023.10145984, describes this known effect in more detail.

It will further be noted that even though NAND flash memory technology is mature and continues to dominate the market for electronic memories used in mass-storage devices, these memories may also suffer from a non-negligible bit error rate when subjected to a high number of write/erase cycles and/or when storage of several bits per cell is attempted. The IDC white paper by N. Sundby and D. Taylor, “Beyond capacity: storage architecture choices for the modern datacenter” published by IDC Analyze the Future, reviews these topics.

One known way of addressing a high bit error rate in a memory of one of these types is to use protection based on error-correcting code (ECC).

An error-correcting code may be implemented by installing an ECC encoder and decoder inside or near the memory controller. Generally, a memory controller is an electronic circuit the function of which is to translate requests, in general from a host electronic system, to perform read or write operations on memory systems.

The general principle applied when encoding data with an ECC is to add check bits to the data bits using an encoder. The check bits are calculated from the data bits, and the resulting ensemble forms a code word. During an operation of decoding via an ECC decoder, the presence of the check bits makes it possible to detect and correct errors affecting both the data bits and check bits.

The code words of a binary and linear ECC may be defined by the following equation:

$$H \cdot v = 0 , \qquad ( 1 )$$

where v is a vector corresponding to a code word, and where H corresponds to a parity matrix containing only binary values (‘0’ or ‘1’) and each column of which is different from the other columns, and contains at least one value other than 0.

During read-out of the data present in the memory, each code word that is read (i.e. each vector v) is checked by evaluating the value of the matrix product H·0.

The result of this operation is a binary vector called a “syndrome”. If the syndrome is a zero vector, i.e. each of the bits of the vector is equal to zero, the code word is considered to be correct. Conversely, a non-zero syndrome indicates the presence of at least one error in the code word.

In addition, if a syndrome makes it possible to identify the positions of the erroneous bits, the code word may be corrected.

In the presence of high bit error rates, one solution is to use increasingly powerful ECCs, i.e., ECCs that make it possible to correct more and more erroneous bits in a code word.

However, this leads to an increasingly great additional cost in terms of footprint, i.e. the footprint required to store the check bits, and in terms of latency and footprint (consumption) of the ECC decoder.

Thus, when faced with the problem of correcting errors in resistive memories or flash memories, there remains a need for a solution that overcomes the various drawbacks of known solutions, and in particular drawbacks related to the latency and footprint of the ECC decoder.

### SUMMARY OF THE INVENTION

The present invention meets this need.

One subject of the invention is a device for reducing the cost of the circuits used to correct errors affecting the words read from memories protected by an error-correcting code (ECC).

The invention more particularly addresses resistive memories and flash memories protected by an error-correcting code that makes it possible to correct at least two erroneous bits per code word stored in memory.

The device of the invention relates to an ECC decoder, which advantageously has a smaller footprint and improved performance in respect of latency.

Generally, for an ECC making it possible to correct up to r erroneous bits per code word obtained during a memory read operation, the device according to the invention combines a correcting module capable of correcting up to r−1 erroneous bits per code word, and a detecting module making it possible to check the number of erroneous bits per code word.

More specifically, the detecting module is arranged to detect whether the initial code word contains at most r−1 erroneous bits, and, if it does not, to initiate a sequence of decoding operations on a succession of words, each of which contains a single inverted bit with respect to the initial code word.

A check is then carried out to check whether the number of erroneous bits in the version of the code word with inversion of one bit has become correctable, i.e. whether the number of erroneous bits has dropped below r. As soon as this condition is met, the code word may be corrected.

Thus, the principle of the invention is based on implementation and use of an ECC decoder of lower functional complexity, smaller footprint and lower latency than an ECC decoder composed of a single combinatorial module.

In order to achieve the sought aim, a device for correcting errors in code words is provided, a code word comprising a data word formed from data bits and comprising check bits. The device of the invention comprises a combination of means or modules including (a) means for receiving a code word with potential errors, the word being read from a memory protected by an error-correcting code having a maximum correction capacity of r erroneous bits per code word.

The device of the invention in addition comprises (b) a decoding module that comprises: —means for generating a binary vector or syndrome for the received code word or for a version of the code word with inversion of one bit, a code word with inversion of one bit being a word obtained from the received code word by inverting the value of a single bit; and —correcting means for generating, from the syndrome, an error vector allowing up to r−1 erroneous bits to be corrected.

The device of the invention in addition comprises (c) an evaluating module for determining the number of erroneous bits in a code word, which comprises: —detecting means for detecting, based on the syndrome, whether the number of erroneous bits in the received code word or in a version of the code word with inversion of one bit, is greater than or equal to r; —analyzing means for deciding whether to perform a bit inversion operation; and —inverting means for inverting one bit in the code word.

The device of the invention in addition comprises (d) outputting means for delivering a data word corrected by the error vector, when the number of erroneous bits in the received code word or in a version of the code word with inversion of one bit, is less than r.

According to one aspect of the invention, the means for generating a syndrome make it possible to evaluate the value of a matrix product H·v, where H corresponds to a parity matrix and where v is a vector corresponding to a received code word or to a code word with inversion.

In one variant of embodiment, the correcting means comprise a combination of logic gates for generating an error vector, each bit of the error vector being an input of an exclusive-or gate of the outputting means.

In one implementation, the detecting means comprise a combination of logic gates for generating a signal indicating the presence of at most r−1 erroneous bits in the received code word or in a code word with inversion of one bit, said signal being an input of the analyzing means.

According to one aspect of the invention, the analyzing means comprise a finite state machine driven by the output of the detecting means and the output of the inverting means, said finite state machine making it possible to determine whether a new decoding cycle needs to be carried out by the error-correcting device, and to command the inverting means to invert a single bit in the received code word.

In one variant of embodiment, the evaluating module in addition comprises parity-calculating means making it possible to generate a total parity signal, said total parity signal making it possible for the analyzing means, in combination with the signal received from the detecting means, to detect whether an uncorrectable error is present.

In one implementation, the correcting means are designed using logical optimization methods making it possible to process data of “don't care” type.

In one variant of embodiment, the means for generating syndromes are designed to generate oversized syndromes having a number of bits greater than the number of check bits of the code word.

Another subject of the invention covers an electronic system of FPGA or ASIC type, comprising a resistive memory or a flash memory, an ECC encoder and an error-correcting device according to the invention.

The invention also provides a method for correcting errors in code words, a code word comprising a data word formed from data bits and comprising check bits.

The method of the invention comprising steps of:
receiving a code word with potential errors, the word being read from a memory protected by an error-correcting code having a maximum correction capacity of r erroneous bits per code word;
in a first decoding cycle:
   decoding the received code word;
   determining whether the code word contains a number of erroneous bits less than or equal to r−1; and if not
   inverting one data bit in the code word to generate a version of the code word with inversion of one bit;
repeating a new decoding cycle with the above steps for each version of the code word with inversion of one bit that is generated, until the number of erroneous bits is greater than r−1 or until a maximum number of bits to be inverted is reached, the step of inverting one bit consisting, in each new cycle, in returning the value of the bit inverted in the previous cycle to its initial state, and in inverting the value of a new bit in the received code word; and
delivering a corrected data word if the number of erroneous bits in the received code word or in a version of the code word with inversion of one bit is less than r.

In one embodiment, the method comprises, before the step of determining whether the code word contains a number of erroneous bits less than r, a step of calculating total parity, making it possible to determine whether an uncorrectable error is present in the code word.

Advantageously, the method of the invention is implemented in an electronic system of FPGA or ASIC type, comprising a resistive memory or a flash memory, an ECC encoder and an error-correcting device according to the invention.

### DESCRIPTION OF THE DRAWINGS

Other features, details and advantages of the invention will become apparent on reading the description given with reference to the appended drawings, which are given by way of example and in which, respectively:

FIG. 1 illustrates one example of an architecture of an error-correcting device according to the invention;

FIG. 2 illustrates the various steps of an error-correcting method implemented by a device such as shown in FIG. 1;

FIG. 3 illustrates one variant of an architecture of an error-correcting device according to the invention with detection of uncorrectable errors;

FIG. 4 illustrates the steps of an error-correcting method implemented by a device such as shown in FIG. 3;

FIG. 5 shows a table comparing improvements in footprint and clock period for various types of ECCs and circuits implementing devices according to the invention;

FIG. 6 shows a graph of the average number of additional decoding cycles (clock cycles) vs bit error rate per bit for prior-art decoders and decoders according to the invention.

### DETAILED DESCRIPTION

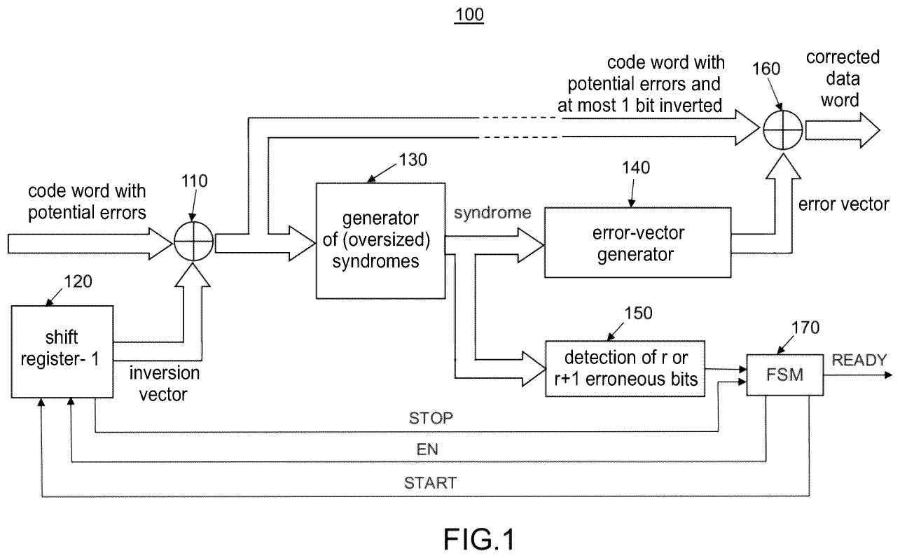

FIG. 1 illustrates one embodiment of an error-correcting device 100 according to the invention, also referred to as an ECC decoder, and able to be used with an ECC allowing correction of at most r erroneous bits per code word read from a resistive memory or flash memory.

This device may be implemented in an architecture that generally incorporates a host electronic system, a memory controller and a (resistive or flash) memory.

The host may consist of one or more processor cores, a microcontroller, a field-programmable gate array (FPGA), or an application-specific integrated circuit (ASIC).

The memory controller controls the memory write and read operations. It comprises an ECC encoder and decoder implemented according to the described variants of embodiment.

In variants of embodiment, the error-correcting code may be a double error correcting (DEC), double error correcting and triple error detecting (DEC-TED), triple error correcting (TEC), triple error correcting and quadruple error detecting (TEC-QED), quadruple error correcting (QEC) or quadruple error correcting and quintuple error detecting (QEC-QED) code.

FIG. 1 shows the functional blocks of the device 100 of the invention, and the flows of data between the various blocks.

The device according to the invention, to correct errors in code words, where a code word comprising a data word formed from data bits and comprising check bits, comprises:
means 110 for receiving a code word with potential errors, the word being read from a resistive memory or flash memory, the memory being protected by an error-correcting code having a maximum correction capacity of r erroneous bits per code word;
a decoding module that comprises: —means 130 for generating a binary vector or syndrome for the received code word or for a code word with inversion of one bit resulting from the received code word, a code word with inversion of one bit being a word obtained from the received code word and in which the value of a single bit is inverted; and —correcting means 140 for generating, from the syndrome, an error vector allowing up to r−1 erroneous bits in the data word to be corrected;
an evaluating module for determining the number of erroneous bits in the code word, which comprises: —detecting means 150 for detecting, based on the syndrome, whether the number of erroneous bits in the received code word or in a code word with inversion of one bit, is greater than or equal to r, —analyzing means 170 for deciding whether to perform a bit inversion operation on the code word; and —inverting means 120 for inverting one bit in the code word;
outputting means 160 for delivering a corrected data word when the number of erroneous bits in the received code word or in a code word with inversion of one bit, is less than r.

The ECC decoder 100 receives as input a code word containing potential programming, storage or read errors (i.e. erroneous bits). Each bit of the received code word passes through an exclusive-or (XOR) logic gate 110. Each XOR gate is controlled by a bit of an inversion vector delivered by inverting means 120.

In one embodiment, the inverting means comprise a shift register 120 for storing an inversion vector having a number of bits equal to the number of bits in the code word minus r−1. Among these bits, at most a single bit may be equal to 1 in order to invert the value of at most a single bit in the word input into the ECC decoder.

A code word output by the input logic gates 110 is addressed to a decoding module composed of means 130 for generating a binary vector or syndrome for the received word.

A word received as input by the syndrome generator 130 is a code word with potential errors that will have or not have had a single bit inverted, depending on the value of the inversion vector.

On initialization, all the bits of the inversion vector are set to zero so that each bit of the received code word passing through the XOR gate 110 preserves its initial value.

On each decoding iteration, all the bits of the inversion vector are shifted by one position with 0 or 1 being provided as input to the flip-flop located at the input of the shift register, i.e. at the end opposite the direction of the shift. The input value 1 is used just in the first shift operation to produce an inversion vector containing a single 1 and a version of the code word called the “code word with inversion of one bit”, which is addressed to the syndrome generator.

The syndrome generator 130 implements multiplication operations to obtain the matrix product H·v of equation (1), where the vector v is a code word with potential errors, either received as input by reading the memory, or a code word with inversion of one bit generated in a subsequent decoding cycle.

From the syndrome, an error-vector generator 140 generates one check bit for each data bit, the set of all the check bits being the error vector.

Each data bit may be corrected using an exclusive-or (XOR) logic gate 160 with two inputs, one input for the bit to be corrected and another input driven by the corresponding check bit in the error vector.

Thus, the output of the syndrome generator 130 is an input of the correcting means 140, which are arranged to generate an error vector making it possible to correct up to r−1 bits of erroneous data in the word output by the module 110.

In one advantageous embodiment, the correcting means 140 are designed with design tools that allow optimizations of Boolean logic in order to process inputs of DC type, DC standing for “don't care”.

Such optimization methods are for example described in the article “Synthesis of Irregular Combinational Functions with Large Don't Care Sets” by V. Gherman et al. (DOI: 10.1145/1228784.1228856).

The notion of DC is defined in conjunction with incompletely specified Boolean functions, i.e.,

$$f : {\{ 0 , 1 \}}^{N} \to \{ 0.1 , X \}$$

where X is an undefined value that may be 0 or 1, in the case of a hardware implementation of f. The combinations of N bits,

y∈{0,1}^{N}
in the domain of definition of f, that are mapped to X are called DCs.

Advantageously, in the presence of a high number of DCs, it becomes possible to obtain hardware implementations of a function f that are more optimized in terms of latency, of footprint or of dissipated power.

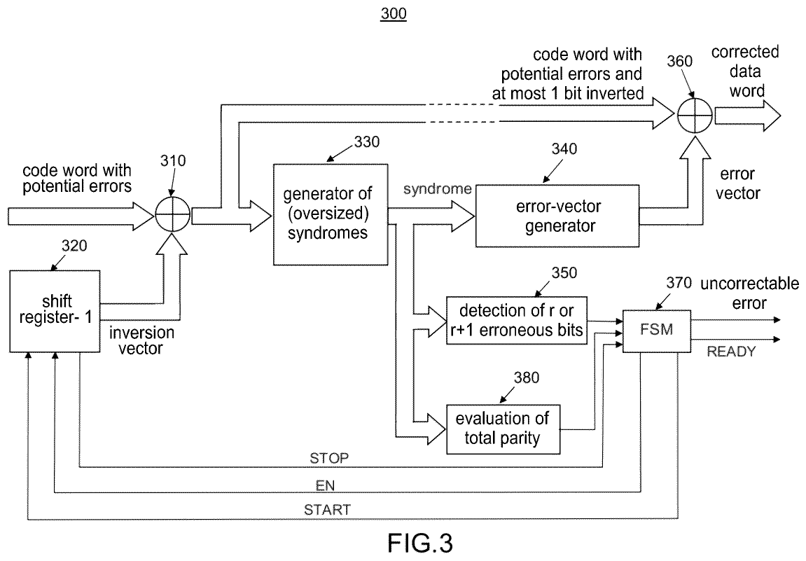

Thus, a high number of DCs may be identified for functions implemented by the correcting module 140 (and similarly by the correcting module 340 of the variant of FIG. 3).

In this way, all the syndromes generated for errors that affect r and r+1 bits may be considered to be data of DC type because, in these cases, the output of the ECC decoder is not used. This particular type of DCs are considered to be so-called observability DCs.

In one variant of embodiment, the number of DCs for the correcting means 140 (and 340) may be further increased by generating oversized syndromes with the syndrome generator 130 (and similarly with the syndrome generator 330 of FIG. 3), i.e. syndromes having a number of bits greater than the number of check bits of the code word.

Such oversized syndromes may be generated by adding redundant rows to the parity matrix H, e.g. rows that are linear combinations of already existing rows. For each additional bit added to the syndromes, the number of possible combinations receivable as input by the module 130 (or 330) is multiplied by 2.

In such a process, only the number of DCs can increase because the value of each redundant syndrome bit is defined by the values of non-redundant syndrome bits. Therefore, for each combination of non-redundant syndrome bits, there is only one possible combination of redundant syndrome bits, and any other combination of redundant syndrome bits cannot occur. All the combinations of syndrome bits that contain unachievable redundant-syndrome-bit values are considered to be so-called controllability DCs.

Returning to FIG. 1, the output of the syndrome generator is also an input of the detecting means 150 of the evaluating module.

The detecting means are arranged to make it possible, by evaluating the syndrome, to detect r or r+1 erroneous bits in the code word output by the module 110.

The output of the module 150 is used by a finite state machine 170 or FSM to use the acronym.

The finite state machine makes it possible to determine whether a new decoding cycle must be performed by the ECC decoder.

The FSM drives the shift register 120 through START and EN signals. During the first decoding cycle, if at least r erroneous bits are detected in the code word received as input by the device 100 (and output by the module 110, the inversion vector being in its initial state, all values being set to 0), the two signals START and EN take the value 1 and the FSM forces a new decoding cycle to start. The first bit of the register 120 is set to the value 1. In this way, the bit of the received code word fed to the first XOR gate is inverted. At the same time, a new decoding cycle is performed with the version of the code word the first bit of which is inverted.

In each subsequent decoding cycle, the signal START is reset to 0 and the signal EN is kept at 1, for as long as a number r or r+1 of erroneous bits is detected, i.e. until the cycle in which decoding finally succeeds. The signal EN makes it possible to reset all the bits of the register 120 to zero.

Thus, after each unsuccessful decoding cycle, i.e. each decoding cycle in which the detecting module 150 indicates the presence of at least r erroneous bits in the version of the word output by the module 110, the value 1 is advanced by one position in the register 120 so that another bit of the word input into the device 100 is inverted.

The iterative decoding-operation process stops either when the detecting module 150 indicates a number of at most r−1 erroneous bits (i.e. a number of errors correctable by the error vector), or when the value 1 is assigned to the bit in the last position in the shift register 120.

Each decoding cycle may be executed in a clock cycle that controls the device 100.

After the successful decoding cycle, the erroneous data bits in the version of the word output by the input module 110 are corrected using the exclusive-or gates 160, the gates being driven by the bits of the error vector generated by the module 140.

With respect to world outside the device, stoppage of the decoding process is indicated by a signal READY generated as output by the FSM.

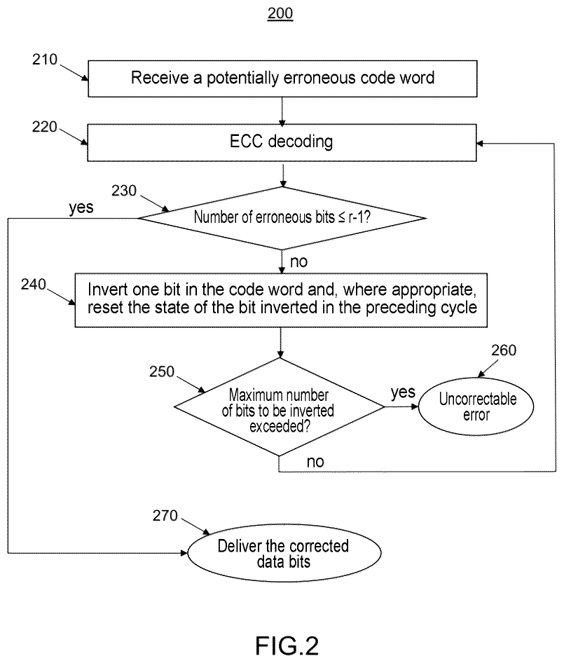

FIG. 2 illustrates the steps of an error-correcting method according to the invention able to be implemented by a device such as shown in FIG. 1.

The method 200 is applicable during read-out of a memory protected by an ECC capable of correcting up to r bits per code word, and makes it possible to improve error correction.

The method begins with a step 210, of receiving a code word that may potentially contain erroneous bits.

In a subsequent step 220, the method allows a first attempt at decoding the code word 220, and makes it possible to check, in a subsequent or simultaneous step 230, whether the number of erroneous bits is less than or equal to r−1.

If the number of erroneous bits is at most r−1, the method allows the erroneous bits to be corrected and allows a corrected word to be delivered in step 270.

According to variants of embodiment, the method makes it possible to deliver either the corrected code word in its entirety or only the corrected data bits (in simplified implementations of the ECC decoder).

Returning to step 230, if the number of erroneous bits is greater than r−1, the method initiates execution of a new decoding cycle for a version of the code word in which a single bit has been inverted. The method comprises a step 240 in which a bit of the initially received code word is inverted.

During execution of a new decoding cycle, except for the first execution, the method resets the bit that was inverted in the previous execution to its initial value.

Thus, in each execution of step 240 a new bit of the code word is inverted.

The method continues to execute new decoding cycles (branch no of 250) as long as the number of erroneous bits is not less than or equal to r−1, or as long as a maximum number of bits to be inverted in the initially received word has not been reached.

When the maximum number is reached, the method generates, in step 260, a signal indicating an uncorrectable error.

The error-correcting method according to the invention makes it possible, for an ECC circuit capable of correcting r erroneous bits per code word, to process up to r−1 erroneous bits in one decoding cycle.

Thus advantageously, the method of the invention, implemented on an optimized device such as that of FIG. 1 or one of its variants of embodiment, makes it possible to reduce the latency and the footprint of the error-correcting logic.

FIG. 3 illustrates one architectural variant of an error-correcting device according to the invention, which comprises additional means for calculating total parity.

The device 300 may be used with an ECC that allows correction of at most r erroneous bits and detection of r+1 erroneous bits per code word.

In this variant, it is assumed that the r+1 erroneous bits are detected using code words having one added total-parity bit, this making it possible to ensure that the resulting code words are all even words or odd words.

Various functional blocks are identical to the blocks in FIG. 1 and hence are not described in detail, the interested reader needing merely to consult the description thereof given above. Thus, blocks or modules 310 to 360 of FIG. 3 are identical to modules 110 to 160 of FIG. 1, respectively.

The device 300 in addition comprises a module 380 for evaluating total parity.

The module 380 is designed to select a syndrome bit that corresponds to the total parity of the word output by the module 310, in the syndrome calculated by the syndrome generator 330, and to send a total-parity signal to the finite state machine 370.

In one variant of embodiment, the syndrome bit corresponding to the total parity may be calculated from all the bits input into the syndrome generator 330, using a tree of XOR gates receiving all these bits as input.

In the variant of FIG. 3, the finite state machine 370 is very similar to the finite state machine of the architecture in FIG. 1, the only difference being that, in the first decoding cycle, the FSM 370 uses the total-parity signal generated as output by the module 380 to identify whether an uncorrectable error affecting r+1 bits is present.

This variant makes it possible to take advantage of the fact that a code word with r erroneous bits has a different total parity to a code word with r+1 erroneous bits, while the output of the module 350 remains the same in both cases.

Thus, in the case where an uncorrectable error is indicated during the first decoding cycle, no additional decoding cycle is initiated and a signal is generated as output by the FSM 370 indicating the presence of an uncorrectable error.

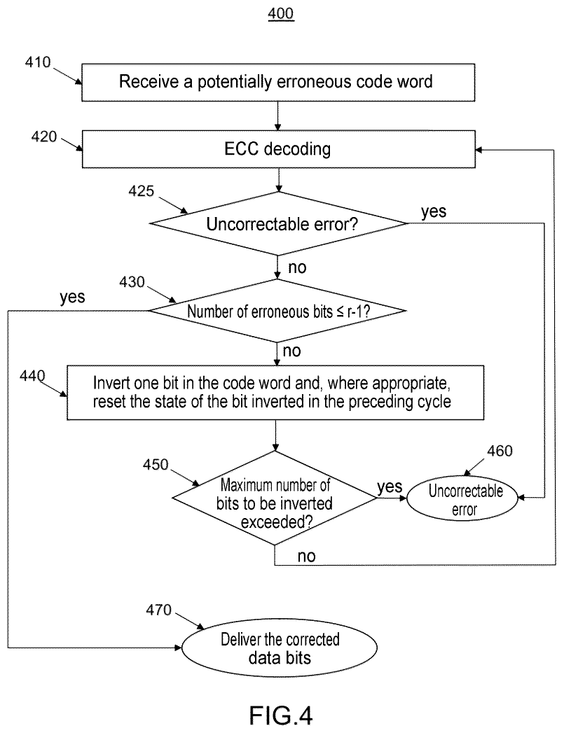

FIG. 4 illustrates the steps of an error-correcting method able to be implemented by a device such as shown in FIG. 3.

The method 400 is applicable during read-out of a memory protected by an ECC capable of correcting up to r bits per code word, and of detecting r+1 erroneous bits per code word.

Various steps are identical to the steps in FIG. 2 and are not described in detail, the interested reader needing merely to consult the description thereof given above. Thus, steps 410, 430, 440, 450, 460 and 470 are identical to steps 210, 230, 240, 250, 260 and 270 of the method 200, respectively.

After receipt in step 410 of a code word potentially containing erroneous bits, the next decoding step 420 identifies the presence of uncorrectable errors in the code word, such as errors affecting r+1 bits.

The result of this detection of uncorrectable errors is processed in step 425. In the case where a number of r+1 erroneous bits is detected, the method continues with a step 460 in order to signal the presence of uncorrectable errors in the code word.

In the case where no uncorrectable errors are detected, the method continues with step 430.

Next, depending on the result of step 430, the method continues with implementation of a loop of decoding cycles on code-word versions with inversion of a single bit, according to steps (440, 450) and in accordance with the corresponding steps (240, 250) described for method 200.

In various embodiments of the methods 200 and 400, the step (240, 440) of inverting a single bit in the code word in each decoding cycle may consist either in applying a unit inversion solely to the data bits of the code word received initially in step 210 or 410, or in applying a unit inversion to all the bits (data bits and check bits) minus r−1 bits of the code word received in step 210 or 410.

In one embodiment in which a BCH ECC is employed (BCH being the acronym of the initials of the inventors of this type of code Bose, Ray-Chaudhuri and Hocquenghem), the detecting modules 150 and 350 (of FIGS. 1 and 3, respectively) may be implemented using a method presented in the paper entitled “Encoding and Error-Correction Procedures for the Bose-Chaudhuri Codes” by W. W. Peterson (DOI: 10.1109/TIT.1960.1057586). This paper introduces matrices called Peterson matrices for BCH ECCs. If the ECC is able to correct up to r erroneous bits per code word, the Peterson matrix Mᵣ₊₁ is singular, i.e., its determinant is equal to 0, if the number of erroneous bits present in a code word is less than or equal to r−1. The Peterson matrix Mᵣ₊₁ is singular if the number of erroneous bits present in a code word is equal to r or r+1.

The method of FIG. 4 may then be adapted to detect an error affecting r bits by evaluating the determinant of the Peterson matrix Mᵣ and the total parity of the received word (equal to r modulo 2 if all the code words are even), and to detect an error affecting r+1 bits by evaluating the determinant of the Peterson matrix Mᵣ₊₁ and the total parity of the received word (equal to r+1 modulo 2 if all code words are even).

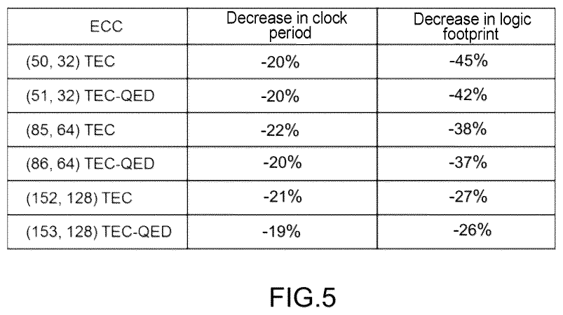

FIG. 5 illustrates the improvement in terms of footprint and clock cycles of various types of ECC and circuits implementing error-correcting devices with architectures such as those shown in FIG. 1 or FIG. 3.

The prior-art ECCs considered are BCH ECCs and allow correction of at most 3 erroneous bits per code word (r=3) for code words with 32, 64 or 128 data bits. The codes in question are identified as being TEC (acronym of Triple-Error Correcting) or TEC-QED (acronym of Triple Error Correcting and Quadruple Error Detecting), depending on whether 4 erroneous bits are detected or not.

The amount of improvement (decrease in clock period and decrease in logic footprint) is calculated with respect to decoders implemented according to solutions presented in the paper entitled “A Low-Complexity Three-Error-Correcting BCH Decoder with Applications in Concatenated Codes” by J. Freudenberger, M. Rajab and S. Shavgulidze (DOI: 10.30420/454862002). All the decoders were synthesized with the Synopsis Design Compiler tool in a 28 nm FDSOI technology.

The iterative-decoding-cycle-based error-correcting approach for example makes it possible to decrease the clock period by as much as −20% for 32-bit TEC codes, in parallel with decreases in logic area of as much as −45%.

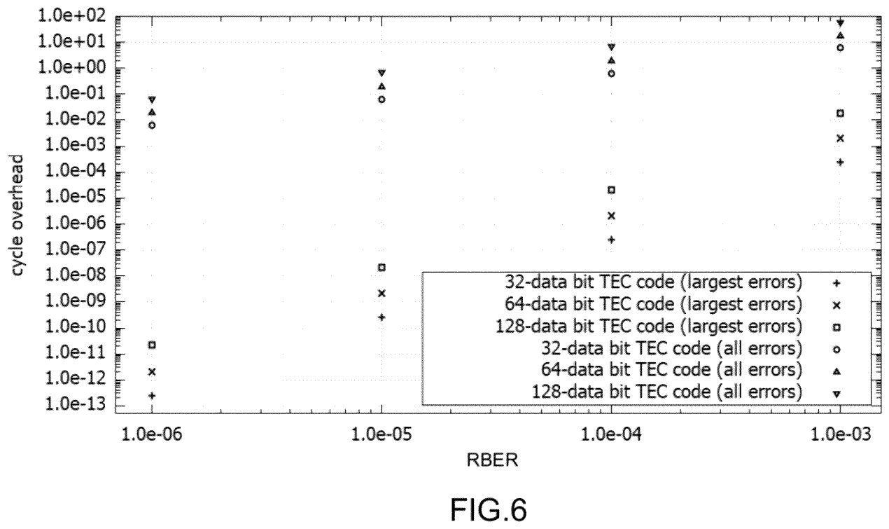

FIG. 6 shows, on a graph, the average number of additional decoding cycles, i.e. cycle overhead, as a function of RBER, i.e. residual bit error rate, for prior-art decoders and decoders according to the invention.

According to the invention, additional decoding cycles are introduced only if the received code word contains a maximum number of correctable erroneous bits. The prior-art decoding (labelled “all errors”) requires additional decoding cycles if the received word contains an erroneous bit. The number of additional cycles is at least equal to (a) the number of data bits plus (b) the maximum number of correctable erroneous bits minus (c) the actual number of erroneous bits. It will be noted that the proposed solution (labelled “largest errors”) has a significant advantage and its extra decoding-cycle cost (clock) becomes negligible with decreasing RBER.

For RBERs below 10⁻⁴, this extra cost drops below 2×10⁻⁷, 2×10⁻⁷ and 2×10⁻⁵ for TEC codes with 32, 64 and 128 data bits, respectively. Entries labelled “all errors” correspond to the extra cost of a known method presented in the paper entitled “Step-by-step decoding of the Bose-Chaudhuri-Hocquenghem codes” by J. Massey (DOI: 10.1109/TIT. 1965.1053833).

In this prior-art approach, although one bit is inverted, this method is strictly different from the method of the invention in respect of (a) correction of code words affected by fewer than r errors and (b) correction of remaining errors once a first erroneous bit has been corrected in the case of r erroneous bits.

In this so-called step-by-step approach, additional erroneous bits are initially injected into the check bits in order to reach a maximum number of r erroneous bits. The method then inverts 1 bit at a time and checks after decoding whether the number of erroneous bits has decreased. If the number of erroneous bits has decreased, the method identifies this inverted bit to be erroneous. Next, the method continues to invert and test all the data bits one by one. Thus a very high number of cycles must be performed once an error is encountered.

In contrast, according to the methods and devices of the invention, if a maximum number of erroneous bits is not detected, the correction takes place in a single cycle (yes branches of steps 230 and 430). This has a major advantage as verified and illustrated in FIG. 6.

The present description illustrates one preferred but non-limiting implementation of the invention. Some examples have been chosen to allow a good understanding of the principles of the invention and a specific application, but these are in no way exhaustive and are intended to allow those skilled in the art to provide modifications and implementation variants for the various circuits while retaining the same principles. In variants of embodiment, each encoding, counting, comparing and inverting functional module may be implemented by means of a dedicated module such as an ASIC.

The invention may be implemented using hardware and/or software elements. It may be available in the form of a computer program product executed by a dedicated processor or by a memory controller of a storage system and comprising code instructions for executing the steps of the methods in their various embodiments.

1. A device for correcting errors in code words, a code word comprising a data word formed from data bits and comprising check bits, the device comprising:
means for receiving a code word with potential errors, the word being read from a memory protected by an error-correcting code having a maximum correction capacity of r erroneous bits per code word;
a decoding module, comprising:
means for generating a binary vector or syndrome for the received code word or for a version of the code word with inversion of one bit, a code word with inversion of one bit being a word obtained from the received code word by inverting the value of a single bit;
correcting means for generating, from the syndrome, an error vector allowing up to r−1 erroneous bits to be corrected;
an evaluating module for determining the number of erroneous bits in a code word, comprising:
detecting means for detecting, based on the syndrome, whether the number of erroneous bits in the received code word or in a version of the code word with inversion of one bit, is greater than or equal to r;
analyzing means for deciding whether to perform a bit inversion operation;
inverting means for inverting one bit in the code word;
outputting means for delivering a data word corrected by the error vector, when the number of erroneous bits in the received code word or in a version of the code word with inversion of one bit, is less than r.

2. The device according to claim 1, wherein the means for generating a syndrome make it possible to evaluate the value of a matrix product H·v, where H corresponds to a parity matrix and where v is a vector corresponding to a received code word or to a code word with inversion.

3. The device according to claim 1, wherein the correcting means comprise a combination of logic gates for generating an error vector, each bit of the error vector being an input of an exclusive-or gate of the outputting means.

4. The device according to claim 1, wherein the detecting means comprise a combination of logic gates for generating a signal indicating the presence of at most r−1 erroneous bits in the received code word or in a code word with inversion of one bit, said signal being an input of the analyzing means.

5. The device according to claim 1, wherein the analyzing means comprise a finite state machine driven by the output of the detecting means and the output of the inverting means, said finite state machine making it possible to determine whether a new decoding cycle needs to be carried out by the error-correcting device, and to command the inverting means to invert a single bit in the received code word.

6. The device according to claim 1, wherein the evaluating module in addition comprises parity-calculating means making it possible to generate a total parity signal, said total parity signal making it possible for the analyzing means, in combination with the signal received from the detecting means, to detect whether an uncorrectable error is present.

7. The device according to claim 1, wherein the correcting means are designed using logical optimization methods making it possible to process data of “don't care” type.

8. The device according to claim 1, wherein the means for generating syndromes are designed to generate oversized syndromes having a number of bits greater than the number of check bits of the code word.

9. An electronic system of FPGA or ASIC type, comprising a resistive memory or a flash memory, an ECC encoder and an error-correcting device according to claim 1.

10. A method for correcting errors in code words, a code word comprising a data word formed from data bits and comprising check bits, the method comprising steps of:
receiving a code word with potential errors, the word being read from a memory protected by an error-correcting code having a maximum correction capacity of r erroneous bits per code word;
in a first decoding cycle:
decoding the received code word;
determining whether the code word contains a number of erroneous bits less than or equal to r−1;
if not, inverting one data bit in the code word to generate a version of the code word with inversion of one bit;
repeating a new decoding cycle with above steps for each version of the code word with inversion of one bit that is generated, until the number of erroneous bits is greater than r−1 or until a maximum number of bits to be inverted is reached, the step of inverting one bit consisting, in each new cycle, in returning the value of the bit inverted in the previous cycle to its initial state, and in inverting the value of a new bit in the received code word; and
delivering a corrected data word if the number of erroneous bits in the received code word or in a version of the code word with inversion of one bit is less than r.

11. The method according to claim 10 comprising, before the step of determining whether the code word contains a number of erroneous bits less than r, a step of calculating total parity, making it possible to determine whether an uncorrectable error is present in the code word.

12. The method according to claim 10, implemented in an electronic system of FPGA or ASIC type comprising a resistive memory or a flash memory, an ECC encoder and an error-correcting device for correcting errors in code words, a code word comprising a data word formed from data bits and comprising check bits, the device comprising:
means for receiving a code word with potential errors, the word being read from a memory protected by an error-correcting code having a maximum correction capacity of r erroneous bits per code word;
a decoding module, comprising:
means for generating a binary vector or syndrome for the received code word or for a version of the code word with inversion of one bit, a code word with inversion of one bit being a word obtained from the received code word by inverting the value of a single bit;
correcting means for generating, from the syndrome, an error vector allowing up to r−1 erroneous bits to be corrected;
an evaluating module for determining the number of erroneous bits in a code word, comprising:
detecting means for detecting, based on the syndrome, whether the number of erroneous bits in the received code word or in a version of the code word with inversion of one bit, is greater than or equal to r;
analyzing means for deciding whether to perform a bit inversion operation;
inverting means for inverting one bit in the code word;
outputting means for delivering a data word corrected by the error vector, when the number of erroneous bits in the received code word or in a version of the code word with inversion of one bit, is less than r.
